(19) United States
(12) Patent Application Publication
(10) Pub. No.: US 2016/0061646 A1
(43) Pub. Date: Mar. 3, 2016

(54) METHOD OF CALIBRATING A LEVEL SENSOR

(71) Applicant: AREVA NP, Courbevoie (FR)

(72) Inventors: William MESTIVIER, Voisins le Bretonneux (FR); Sylvain SERRANO, Houilles (FR)

(21) Appl. No.: 14/781,550

(22) PCT Filed: Apr. 4, 2014
(86) PCT No.: PCT/EP2014/056874

§ 371 Date: Sep. 30, 2015

(30) Foreign Application Priority Data
Apr. 4, 2013 (FR) 1353044

(51) Int. Cl. G01F 25/00

(52) U.S. Cl. CPC G01F 25/0061

(57) ABSTRACT

A method of calibrating a level sensor is provided. The level sensor includes a tube, a lower part of which communicates with a liquid volume, an upper part not being filled with the liquid; and a device for measuring a level of the free surface of the liquid along the tube. The method includes placing the upper part of the inner space at a predetermined pressure; computing a theoretical level of the surface of the liquid; acquiring the measured level measured by the measuring device; comparing the theoretical level and the measured level; and repeating the steps for computing a theoretical level, acquiring a measured level and comparing the theoretical and measured levels after placing the upper part of the inner space at least at a second predetermined pressure.

The invention generally relates to level sensors, in particular float level sensors.

More specifically, the invention relates to a method of calibrating a level sensor, the sensor comprising:
a tube delimiting an inner space, the tube being submerged in a volume of liquid, the inner space having a lower part communicating with the liquid volume through an opening arranged in the tube, the lower part being filled with the liquid, an upper part of the inner space not being filled with the liquid and being separated from the lower part by a free surface of the liquid;
a device for measuring the level of the free surface along the tube;
   the method comprising the following step:
placing the upper part of the inner space at a predetermined pressure.

### BACKGROUND

GB-1,533,655 describes a float sensor forming a level detector. The float floats on the free surface of the liquid. The sensor further has a device provided to detect that the float has reached a low threshold in the tube. It thus performs an “All Or Nothing” measurement, unlike the device described above. GB 1,533,655 further describes a method making it possible to test the proper operation of the sensor, in which the upper part of the inner space of the tube is pressurized, so as to lower the float to its low threshold.

U.S. Pat. No. 4,465,088 describes a minimum level sensor in a boiler and a method making it possible to test the proper operation of the sensor without having to empty part of the boiler. This method consists of artificially creating a level drop in a tube surrounding the sensor by injecting gas into the upper part of the inner space of the tube so as to lower the water level until the signal is activated indicating the low threshold of the sensor.

FR-2,694,622 also describes a method for monitoring the operation of a level sensor, that sensor detecting a maximum water level in an overpressurized steam boiler. Unlike the previous method, this method consists of producing a vacuum by allowing the steam contained in a tube surrounding the sensor to escape to increase the water level in the tube until the maximum level sensor is activated.

Such methods are suitable for testing the proper operation of a level detector of the “All Or Nothing” type, but not for calibrating a float level sensor, provided to measure the level of the float along the tube in an analog manner (continuous measurement).

### SUMMARY OF THE INVENTION

In this context, the invention aims to propose a method of calibrating a level sensor, that is simple and easy to implement.

To that end, the invention provides a method of the aforementioned type, characterized in that the method further comprises the following steps:
computing a theoretical level of the free surface along the tube based on the determined pressure;
acquiring the measured level of the free surface measured by the measuring device;
comparing the theoretical level and the measured level;
repeating the steps for computing a theoretical level, acquiring a measured level and comparing the theoretical and measured levels after placing the upper part of the inner space at least at a second predetermined pressure.

Placing the upper part of the inner space at the predetermined pressure makes it possible to modify the liquid level of the tube. The free surface thus moves inside the tube. The level difference between the free surface of the liquid outside the tube and the free surface of the liquid inside the tube is computed based on the predetermined pressure. This level difference in turn makes it possible to evaluate the theoretical level of the free surface along the tube. This theoretical level is compared to the level measured by the measuring device, so as to verify, by repeating these operations for several predetermined pressures, whether the sensor is working correctly, and in particular whether the levels measured by the measuring device are consistent with the computed theoretical levels.

A calibration method here refers to a method seeking to monitor the accuracy of the quantitative level measurements provided by the level sensor. In GB 1,533,655 and FR 2,694,622, the method simply aims to detect whether the sensor reacts when the float reaches its low or high threshold.

The tube is oriented generally vertically. It may have any type of internal section, for example a circular, oval, rectangular section, etc. It is typically partially submerged in the volume of liquid, a lower segment of the tube being submerged in the liquid volume and an upper segment protruding above the free surface of the liquid.

The opening through which the lower part of the inner space communicates with the liquid volume typically corresponds to an open lower end of the tube. Alternatively, the opening is a window cut laterally in the tube.

The opening has a sufficient size to allow a flow of the liquid between the inside and the outside of the tube, such that when the upper part of the inner space of the tube is at ambient pressure, the liquid level in the tube is the same as in the rest of the volume.

The liquid is typically water, optionally with additives, that could be of any other type.

The predetermined pressure in the upper part of the inner space is chosen so as to move the liquid level in the inner space of the tube to the normal measuring range of the measurement device. Typically, the predetermined pressure is higher than the pressure of the atmosphere outside the tube, so as to decrease the liquid level in the tube. Alternatively, the predetermined pressure is lower than the pressure outside the tube, so as to increase the liquid level in the tube. In that case, a vacuum pump is typically used to place the upper part of the inner volume at the predetermined pressure. This makes it possible to test the entire measuring range of the sensor, even if the liquid level outside the tube is far from the nominal level.

The predetermined pressure is therefore typically higher than the gas pressure at the free surface of the liquid volume outside the tube. It is lower than the pressure of the liquid column between the opening and the free liquid surface outside the tube.

Typically, it is comprised between 0 and 5 absolute bars, preferably between 1 and 3 absolute bars. It is adjusted based on the liquid height in the pool.

The tube is a tight tube, inasmuch as it does not have any other openings between the opening placing the lower part of the inner space in communication with the liquid volume, and the fluid inlet making it possible to place the upper part of the inner space under pressure.

In order to compute the theoretical level of the free surface, the predetermined pressure makes it possible to evaluate the difference between the level of the free surface inside the tube and level of the free surface of the liquid outside the tube. This predetermined pressure is continually corrected by the temperature of the fluid in question, provided by one or more dedicated sensors, and by the pressure of the enclosure in question, provided by one or more dedicated sensors. The measuring device provides the level of the free surface relative to a reference point, which may be the bottom of the tube, or the level of the opening, or any other point. To perform the comparison between the theoretical level and the measured level, the level of the free surface of the liquid in the volume relative to the reference point of the measuring device is also taken into account. This property is acquired using any suitable means. It is for example evaluated by computation, by pressurizing the upper part of the inner space, as described below. Alternatively, it is evaluated using temporary level measuring means, recovered in a computer or considered to be known.

Typically, the calibration of the sensor is considered to be satisfactory if the deviation between the theoretical level and the measured level is below a predetermined limit, in absolute value.

According to one advantageous feature of the invention, the level sensor is a float sensor, comprising a float positioned in the inner space of the tube floating on the free surface of the liquid, the measuring device being provided to measure a level of the float along the tube.

The float is typically a body with a density lower than that of the liquid, which floats on the free surface of the liquid and is free to move in the inner space of the tube. It follows the level of the free surface of the liquid.

The device for measuring the level of the float along the tube is of any suitable type. It allows a qualitative measurement of the distance along the axis of the tube between a reference point and the float. The measuring device may be of the magnetic type, made up of a float containing a magnet sliding around a measuring device containing flexible leaf switches reacting to the passage of the magnet. The opening/closing of the switches makes it possible to measure the level.

Alternatively, the measuring device may also be outside the tube, the float therefore being free inside the tube.

Alternatively, the level sensor is not of the float type but the capacitive type, or the thermal dispersion type, or is a wire-guided radar.

According to one advantageous feature of the invention, the upper part of the inner space is pressurized by injecting a gas. This gas is typically air.

This makes it possible to adjust the pressure in the upper part of the inner space, quickly and precisely. The gas comes from a pressurized gas source. For example, it comes from a compressor or a pressurized gas canister, connected to the inner space by an expander. The pressure of the gas blown into the inner space is adjustable.

According to another advantageous feature of the invention, the upper part of the inner space is successively placed at a plurality of predetermined pressures different from one another, the steps for computing a theoretical level of the free surface along the tube, acquiring the measured level of the free surface measured by the measuring device, and comparing the theoretical level and the measured level being repeated for each of said predetermined pressures.

Thus, the method makes it possible to calibrate the sensor over a broad level range. Preferably, the determined pressures are chosen to make it possible to test the entire measuring range of the level sensor. Certain predetermined pressures then correspond to levels of the free surface close to the upper bound, others to levels of the free surface close to the lower bound, and still others to intermediate levels.

It is for example possible to increase the pressure in the upper part of the inner volume by plateaus and to repeat the steps for computing the theoretical level and acquiring the measured level at each plateau. It is also possible to proceed in the opposite direction, and to decrease the predetermined pressure by plateau, performing a computation of the theoretical level and acquisition of the measured level at each plateau.

According to another advantageous feature of the invention, the method comprises a prior operation for determining a zero point, said prior operation comprising:
a step for placing the upper part of the inner space at a reference pressure such that the liquid is driven out of the inner space to the level of the opening arranged in the tube;
a step for computing a reference level difference between the free surface of the liquid outside the tube and the opening, based on the reference pressure.

In other words, the reference point for the level sensor here corresponds to the level of the opening. The reference pressure is typically the pressure at which gas bubbles appear leading to the opening of the tube.

In order to detect the appearance of gas bubbles while being at a distance from the sensor (in particular in the event the sensor is installed in a nuclear reactor or fuel storage pool), a camera is advantageously positioned across from the opening of the tube and sends images of the opening of the tube, for example in a remote control room for the pool.

Alternatively, the appearance of the gas bubbles may be detected by monitoring the pressure curve injected in the tube: the increase will be regular until bubbles appear, after which the pressure variation will no longer be regular, the slope of the curve having a “break”.

More specifically, the step for computing the theoretical level of the free surface along the tube comprises the following sub-steps:
computing a liquid level difference between the inner space of the tube and the liquid volume based on the predetermined pressure,
computing the liquid level in the inner space of the tube relative to the opening, based on said level difference and a reference level difference between a free surface of the liquid volume outside the tube and the opening.

As indicated above, it is in fact necessary to know the liquid level outside the tube above the reference point of the sensor, to be able to compare the theoretical level of the free surface of the liquid along the tube (inside the latter) and the measured level of said free surface. The reference point is typically the opening. The level of the free surface of the liquid outside the tube relative to the opening is known using other redundant sensors of a same type, or any other temporary measuring means. Alternatively, the reference level difference is determined during the prior operation for determining the zero point.

Such an evaluation is both convenient and precise, and makes it possible to obtain excellent reliability of the calibration method.

Alternatively, the method does not comprise the prior operation.

According to another advantageous feature of the invention, the prior step for determining the zero point comprises a step for verifying that the level sensor indicates a minimum measured level (zero level) at said reference pressure. The minimum level corresponds to the bottom of the measuring range of the sensor.

Such a prior operation may be followed by a step for recalibrating the zero of the minimum level of the level sensor.

According to another advantageous feature of the invention, the method further comprises a step for acquiring a temperature of the liquid in the liquid volume and/or a gas pressure above the liquid volume, said liquid temperature and/or said gas pressure being used in the step for computing the theoretical level of the free surface along the tube.

In fact, the step for computing the theoretical level of the free surface typically takes a value of the liquid density into account. This density depends on the gas pressure above the liquid volume and the temperature of the liquid. Knowing the structure and/or this pressure makes it possible to increase the precision of the calibration. When the liquid volume is a pool of a nuclear reactor, several redundant measurements of the liquid temperature and gas pressure above the volume of liquid are available. It is possible to use only the temperature values or only the pressure values. It is also possible to use predetermined properties for the temperature and/or the pressure, or to use a predetermined density value.

According to another advantageous aspect of the invention, the tube comprises a vent placing the upper part of the inner space of the tube in communication with the atmosphere when the level sensor is in use, the upper part of the inner space being pressurized during the calibration by connecting the vent to a pressurized gas source.

The vent normally places the inner space of the tube in communication with the atmosphere, which makes it possible to suction or expel air based on liquid level variations in the volume. The method therefore uses a pre-existing vent, which is particularly convenient and cost-effective.

Alternatively, the upper part of the inner space is pressurized via another orifice, for example a connection dedicated to calibration.

According to another advantageous feature of the invention, the method comprises a step for verifying the response time of the level sensor, done by quickly modifying the pressure of the upper part of the inner space and tracking the evolution of the level measured by the level sensor over time.

Typically, this step is performed by breaking the pressure in the upper part of the inner space at the end of the calibration method, so as to return that pressure to the gas pressure level above the liquid volume quickly. It is also possible to create a pressure gap in the upper part of the inner space, by increasing or decreasing the pressure. In order to determine the response time, the acquisition of the measurement from the level sensor is necessary in order to precisely determine the duration necessary to reach a predetermined percentage (typically 63% or another suitable value) of the amplitude of the pressure.

The calibration method is particularly suitable when the liquid volume is a nuclear reactor pool. The pool may be a reactor pool, a fuel storage pool, or any other type of pool. The liquid is water in that case, comprising additives such as boron. In that case, the method is particularly advantageous, since it may be applied while the reactor is operating and/or the nuclear fuel is present in the pool. It does not require disassembling the measuring device to calibrate it in the laboratory. It also does not require emptying and filling the pool, which is time-consuming and creates effluents. The radiation doses received by the operating staff are small in the case of the method according to embodiments of the invention, since the calibration is done essentially remotely from the sensor. The method may, however, be applied to other liquid volumes, for example tanks, in a nuclear reactor or another type of installation. The method also improves the safety of the operating staff, since no assembly/disassembly is necessary, which limits the associated accident risks.

### BRIEF SUMMARY OF THE DRAWINGS

Other features and advantages of the invention will emerge from the following detailed description, provided for information and non-limitingly, in reference to the appended figures, in which:

FIG. 1 is a diagrammatic sectional illustration of the pool of a nuclear reactor equipped with a low level sensor;

FIG. 2 is a flowchart diagrammatically showing the prior operation for determining the zero point of the sensor; and

FIG. 3 is a flowchart diagrammatically showing the main steps of the method according to an embodiment the invention.

### DETAILED DESCRIPTION

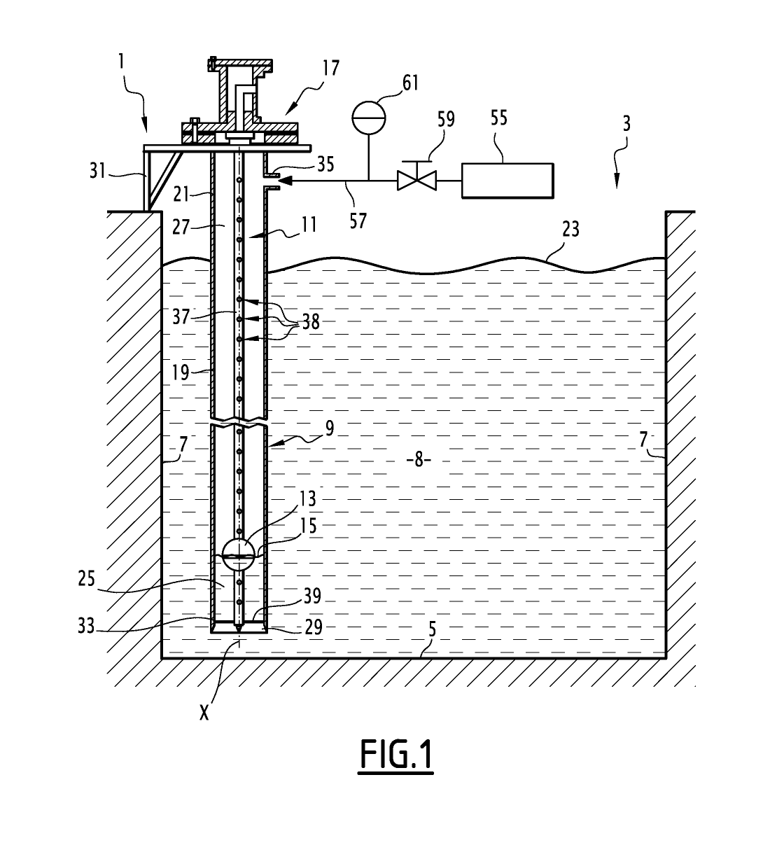

The method according to an embodiment of the invention is designed to calibrate a float sensor 1 arranged to measure the liquid level in a volume 3. In the example shown in FIG. 1, the volume 3 is a pool of a nuclear reactor. The pool is delimited by a bottom 5 and side walls 7 and is upwardly open. The liquid 8 contained in the pool is water comprising different additives, such as boric acid. The pool 3 is housed in a building, not shown, the pressure of the gas above the pool, inside the building, being controlled at a predetermined known value. The temperature of the liquid in the pool is measured by probes, not shown.

The level sensor 1 comprises:
a tube 9 delimiting an inner space 11, the tube 9 being submerged in the liquid 8;
a float 13, positioned in the inner space 11 of the tube and floating on a free surface 15 of the liquid inside the tube;
a device 17 for measuring the level of the float 13 along the tube 9.

As shown in FIG. 1, the tube has a lower segment 19 submerged in the liquid volume 8, and an upper segment 21 protruding above the free surface 23 of the liquid volume. Thus, the inner space 11 has a lower part 25 filled with the liquid and an upper part 27 not filled with the liquid.

The lower part 25 communicates with the liquid volume 8 through an opening 29.

The tube 9 here has a central axis X with a substantially vertical orientation. The upper segment 21 is rigidly fastened to the side wall 7 of the pool via a support 31. The tube 9 is hollow, with a substantially constant straight section, circular in the illustrated example. The opening 29 here is delimited by a lower free end 33 of the tube.

The tube 9 also comprises a vent 35, arranged in the upper segment 21, above the free surface 23 of the liquid outside the tube. The vent 35 puts the upper part 27 of the inner space of the tube in communication with the atmosphere of the building.

Here, the float 13 is a ball made from one or more materials chosen such that the density of the float 13 is lower than the density of the liquid.

The measuring device 17 comprises a guide rod 37 for the float, and detectors 38 arranged over the entire length of the rod 37 to determine the position of the float along the axis X, along the tube. The rod 37 extends along the axis X. It is rigidly fastened by an upper end to the support 31 and by a free lower end to the lower end 33 of the tube 9. It is connected to the end 33 by rigid spacers 39, arranged so as not to block the flow of the fluid through the opening 29. The float 13 has a central passage extending along a diameter of the float 13, in which the rod 37 is engaged. The float 13 is free to slide along the rod 37, freely following the liquid level inside the inner space 11. The detectors 38 (flexible leaf switches) arranged over the entire length of the rod 37 are regularly distributed, with a precisely constant distance between each detector. The magnet incorporated into the float 13 makes it possible to measure the position of the float 13 based on the detectors 38 actuated by the magnet.

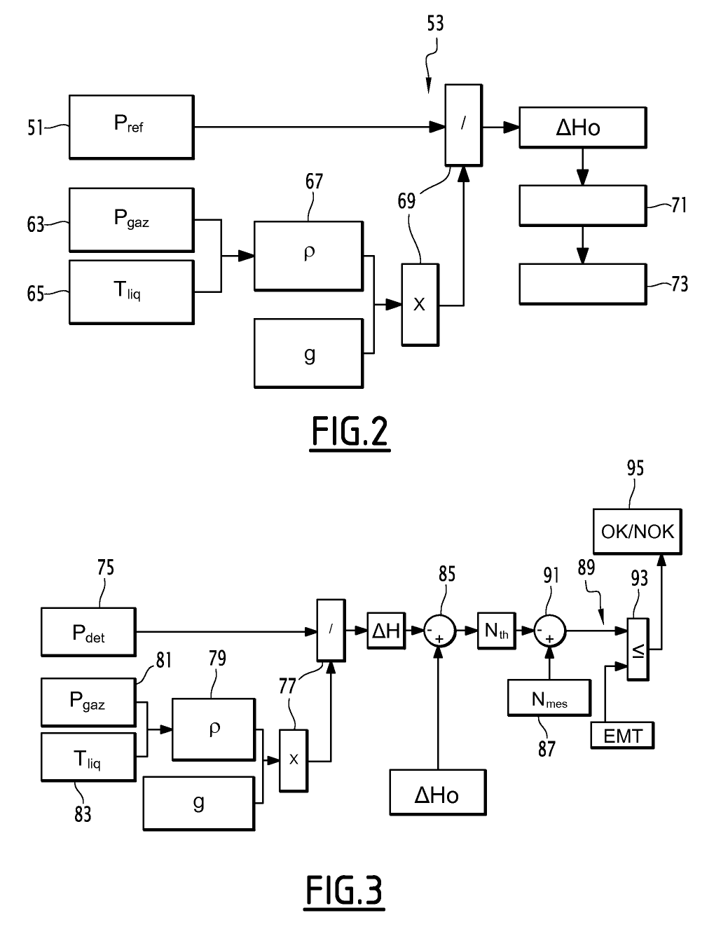

The calibration method according to an embodiment of the invention is shown in FIGS. 2 and 3.

As illustrated in FIG. 2, it preferably comprises a prior operation for determining the zero point of the level sensor, done before calibrating the sensor as shown in FIG. 3.

The prior operation comprises:
a step 51 for placing the upper part 27 of the inner space at a reference pressure P_{ref} such that the liquid is expelled from the inner space up to the level of the opening 29 arranged in the tube;
a step 53 for computing a reference level difference ΔHo between a free surface of the liquid outside the tube 9 and the opening 29, based on the reference pressure P_{ref} established in step 51.

As shown in FIG. 1, the upper part 27 of the inner space is pressurized by connecting the vent 35 to a pressure source 55. The pressure source 55 is for example a compressor or a pressurized gas canister. It is connected to the vent 35 by a line 57 on which a member 59 for adjusting the pressure and a member 61 for measuring the pressure inside the duct 57 downstream from the member 59 are inserted. The member 59 is suitable for adjusting the gas pressure in the upper part 27 of the inner space.

The reference pressure P_{ref} is determined by gradually increasing the gas pressure in the upper part of the inner space, by acting on the member 59. The pressure increase is stopped once bubbles appear. These bubbles correspond to gas escaping through the opening 29, situated at the lower end of the tube.

The reference pressure P_{ref} corresponds to the height difference of the water column between the free liquid surface 23 and the opening 29. The level difference between the free surface 23 and the opening 29 is computed in step 53 using the following equation:

ΔHo=P_{ref}/(ρ·g)

where P_{ref} is the pressure difference, ΔHo is the reference level difference between the free surface 23 and the opening 29, ρ is the density of the liquid, and g is the gravitational constant.

Step 53 comprises the following sub-steps:
sub-steps 63 and 65 for acquiring the gas pressure P_{gaz} in the enclosure above the free surface 23 of the liquid, and the temperature T_{liq} of the liquid in the pool;
sub-step 67 for computing the density ρ of the liquid, as a function of the values of P_{gaz} and T_{liq} acquired in sub-steps 63 and 65;
sub-step 69 for computing ΔHo, using the equation above based on the density ρ determined in sub-step 67.

The density is computed using predetermined tables or algorithms, which are specific based on the composition of the liquid.

Step 53 is generally followed by a step 71 for verifying the zero point of the sensor. The upper part of the inner spaces is kept at P_{ref}. The level measured by the sensor is read. One then verifies that the level corresponds to the maximum level measurable by a level sensor, i.e., the low level of the measuring range (zero level).

If the measured level is not equal to the minimum measurable level, the zero point of the sensor may be corrected by an offset in the command control to which the measuring device 17 is connected (step 73). It may also indicate a failure of the measuring device 17, which may lead to replacing the level sensor 1.

According to the calibrating method of this embodiment of the invention, the set of steps shown in FIG. 3 is repeated several times, the upper part of the inner space being placed at a different predetermined pressure in each iteration. Only one iteration will be described below.

As illustrated in FIG. 3, the upper part 27 of the inner space 11 is placed at a predetermined pressure P_{det} (step 75 in FIG. 3). To that end, the same device is typically used as during the prior operation. The predetermined pressure is lower than the reference pressure. In step 77, the level difference between the free surface 23 of the liquid outside the tube and the float 13 is next computed. That value ΔH is computed using the following equation:

ΔH=P_{det}/(ρ·g)

where ΔH is said level difference, P_{det} is the predetermined pressure imposed in the upper part 27 of the inner space, ρ is the density of the liquid, and g is the gravitational constant.

As for the prior operation, the density ρ is computed in step 79 after acquiring the gas pressure in the enclosure above the free surface 23 of the liquid and the liquid temperature in the pool (steps 81 and 83).

The theoretical level Nₜₕ of the float 13 is next determined in step 85, using the following equation:

Nₜₕ=ΔHo−ΔH

The theoretical level Nₜₕ of the float 13 corresponds to the separation along the axis X between the float 13 and the opening 29.

The value of ΔHo used is that which was determined during the prior operation, shown in FIG. 2.

In step 87, the measured level Nₘₑₛ of the float 13, measured by the level sensor 1, is acquired. This step is performed after any correction of the zero point of the level sensor 1 in step 73. Then, in step 89, the theoretical level Nₜₕ is compared to the measured level Nₘₑₛ. To that end, the difference is computed between the two level values (step 91), and the difference is compared to a predetermined maximum allowed deviation EMT (step 93). If this difference is smaller in absolute value than the maximum allowed deviation EMT, it is considered that the calibration at that pressure is satisfactory (OK in step 95). If the deviation is above the value EMT, it is considered that the calibration is not satisfactory at the considered pressure value (NOK in step 95). In that case, the zero point of the sensor may be corrected by an offset in the command control to which the measuring device 17 is connected. It may also indicate a failure of the measuring device 17, which may lead to replacing the level sensor 1.

What is claimed is:

1-11. (canceled)

12. A method of calibrating a level sensor, the sensor including a tube delimiting an inner space, the tube being submerged in a volume of liquid, the inner space having a lower part communicating with the liquid volume through an opening arranged in the tube, the lower part being filled with the liquid, an upper part of the inner space not being filled with the liquid and being separated from the lower part by a free surface of the liquid, the sensor also including a measurer configured for measuring the level of the free surface along the tube, the method comprising:
placing the upper part of the inner space at a predetermined pressure;
computing a theoretical level of the free surface along the tube based on the predetermined pressure;
acquiring a measured level of the free surface measured by the measurer;
comparing the theoretical level and the measured level; and
repeating the computing a theoretical level, acquiring a measured level and comparing the theoretical and measured levels after placing the upper part of the inner space at least at a second predetermined pressure.

13. The calibration method as recited in claim 12 wherein the level sensor is a float sensor, the float sensor including a float positioned in the inner space of the tube and floating on the free surface of the liquid, the measurer being provided to measure a level of the float along the tube.

14. The calibration method as recited in claim 12 wherein the upper part of the inner space is pressurized by injecting a gas.

15. The calibration method as recited in claim 12 wherein the upper part of the inner space is successively placed at a plurality of predetermined pressures different from one another, the computing a theoretical level of the free surface along the tube, acquiring the measured level of the free surface measured by the measurer, and comparing the theoretical level and the measured level being repeated for each of the predetermined pressures.

16. The calibration method as recited in claim 12 further comprising a prior operation for determining a zero point, the prior operation comprising:
placing the upper part of the inner space at a reference pressure such that the liquid is expelled from the inner space up to the level of the opening arranged in the tube; and
computing a reference level difference between a free surface of the liquid outside the tube and the opening, based on the reference pressure.

17. The calibration method as recited in claim 16 wherein the prior operation for determining the zero point further includes verifying that the level sensor indicates a minimum measured level at the reference pressure.

18. The calibration method as recited in claim 12 wherein the computing the theoretical level of the free surface along the tube comprises the following sub-steps:
computing a liquid level difference between the inner space of the tube and the liquid volume based on the predetermined pressure,
computing the liquid level in the inner space of the tube relative to the opening based on the level difference and a reference level difference between a free surface of the liquid volume outside the tube and the opening.

19. The calibration method as recited in claim 12 further comprising acquiring a temperature of the liquid in the liquid volume and/or a gas pressure above the liquid volume, the liquid temperature and/or the gas pressure being used in the computing the theoretical level of the free surface along the tube.

20. The calibration method as recited in claim 12 wherein the tube includes a vent placing the upper part of the inner space of the tube in communication with the atmosphere when the level sensor is in use, the upper part of the inner space being pressurized during the calibration by connecting the vent to a pressurized gas source.

21. The calibration method as recited in claim 12 further comprising verifying the response time of the level sensor by quickly modifying the pressure of the upper part of the inner space and tracking the evolution of the level measured by the level sensor over time.

22. The calibration method as recited in claim 12 wherein the liquid volume is a pool of a nuclear reactor.
